(19) United States
(12) Patent Application Publication
(10) Pub. No.: US 2010/0119881 A1
(43) Pub. Date: May 13, 2010

(54) ELECTRONIC CURRENT INTERRUPT DEVICE FOR BATTERY

(75) Inventors: Aakar Patel, Pleasanton, CA (US); Marc Juzkow, Livermore, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Leyden Energy, Fremont, CA (US)

(21) Appl. No.: 12/573,072

(22) Filed: Oct. 2, 2009

Related U.S. Application Data
(60) Provisional application No. 61/102,323, filed on Oct. 2, 2008.

(51) Int. Cl. H01M 14/00

(52) U.S. Cl. 429/7

(57) ABSTRACT

The present invention provides a protection circuit disposed in a lithium-ion cell for protection of the lithium-ion cell. The protection circuit includes a first protection module, a second protection module, an integrated circuit module, a thermal sensor or thermocouple, a switch, a fuse and/or a resistor.

### CROSS-REFERENCES TO RELATED APPLICATIONS

This application claims priority to U.S. Provisional Patent Application No. 61/102,323 filed Oct. 2, 2008, which application is incorporated herein by reference in its entirety and for all purposes.

### BACKGROUND OF THE INVENTION

Lithium based cells are easily subject to damage when they are over-discharged, run away temperature or in short circuit conditions. Over-temperature may also cause explosion of the lithium based cells, especially when a number of lithium cells are connected in series and/or in parallel to form a battery assembly to effect high current charging and discharging for devices that require much larger output power than a single cell can provide. In such applications, the lithium cells are easily subject to damage caused by over-discharging and the costs are much higher when the batteries are so damaged. Also, explosion of the batteries is more powerful, if it happens. Any possible short circuit condition is particularly hazardous. A typical lithium ion cell can produce as much 30 amps on a short circuit condition and this can destroy the entire battery. Therefore, a safety device is desirable to detect voltage and temperature of the lithium cell during the operation thereof and to immediately cut off the discharge current at the time when abnormal events occur. Such a device must also ensure minimal leakage current when a device having such safety mechanism is put in non-operation condition.

Conventional lithium-ion cells typically utilize a mechanical safety device and a positive thermal coefficient (PTC) device. Almost always a device called a Current Interrupt Device (CID) is utilized. The CID device has three functions: overcharge protection, overvoltage protection and other abusive conditions that lead to increased internal pressure. Increased internal pressure causes a disc (sometimes referred to as the vent disc) to move and separate from another disc (sometimes referred to as the weld disc). Indirectly high temperature can lead to electrolyte decomposition, gas generation and increased internal cell pressure. The movement of the vent disc breaks a weld and disconnects the positive header of the cell from the positive electrode, thus permanently interrupting the flow of current in or out of the cell. The PTC device primarily protects against over current but it will also activate when a high temperature is reached. In an over current situation, increased current through the PTC device increases the device temperature and causes the PTC device resistance to increase several orders of magnitude. Temperature is only utilized by the fact that a high temperature activates the PTC device. This high temperature can result from either an over current through the resistive PTC device or high internal or external temperatures. The PTC device does not totally eliminate the current into or out of the cell; the current is decreased. The major drawback to the PTC device is that its impedance is a significant contribution to the total impedance of the cell. Also, in no way can the CID or PTC devices activate based on absolute temperature or the rate of change of temperature as a function of time.

Therefore, there is a need to develop a protection circuit that detects cell voltage and temperature when abnormal events occur and cuts off the current. The protection circuit has a simple structure, low costs and is easy to incorporate into the lithium-ion cell assembly (can container).

### BRIEF SUMMARY OF THE INVENTION

In one aspect, the present invention provides a protection circuit disposed within a lithium-ion cell assembly, wherein the lithium-ion assembly includes a lithium-ion cell in electrical communication with said protection circuit. The circuit includes a first and a second connection terminals for connecting to a charging device for charging the lithium-ion cell and/or a load device driven by a discharge current from the lithium-ion cell assembly; a first protection module coupled between the lithium-ion cell and the first terminal for conducting or cutting off a first circuit loop between the lithium-ion cell and the first terminal or second terminal; a second protection module coupled between the first protection module and the first terminal for conducting or cutting off a second circuit loop between the lithium-ion cell and the first terminal or second terminal; an integrated circuit module coupled with the first protection module, the second protection module, the lithium-ion cell, the first terminal and the second terminal for monitoring the parameters of the lithium-ion cell and controlling the first and the second protection module to conduct or cut off the first circuit loop, the second circuit loop, or both, between the lithium-ion cell and the first and the second terminals; a thermal sensor coupled to the integrated circuit, wherein the thermal sensor is in contact with the lithium-ion cell for detecting the temperature of the cell; and a resistor coupled between the second protection module and the first terminal for measuring and controlling the current of the lithium-ion cell.

In another aspect, the present invention provides a lithium-ion cell assembly, which includes a protection circuit as described herein and a lithium-ion cell, which is in electrical communication with the protection circuit.

In yet another aspect, the present invention provides a lithium-ion battery, which include one or more lithium-ion cell assemblies, each of the lithium-ion cell assemblies includes a lithium-ion cell and a protection circuit, where the lithium-ion cell is in electrical communication with the protection circuit.

### BRIEF DESCRIPTION OF THE DRAWINGS

FIG. 1 shows a schematic diagram of a lithium-ion cell assembly having a protection circuit connected to a lithium-ion cell according to an embodiment of the invention.

FIG. 2 shows another schematic diagram of a lithium-ion cell assembly having a protection circuit connected to a lithium-ion cell according to an embodiment of the invention.

### DETAILED DESCRIPTION OF THE INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Preferred embodiments of the invention are described in detail below. Referring to the drawings, like numbers indicate like parts. As used in the description herein and throughout the claims, the following terms take the meanings explicitly associated herein, unless the context clearly dictates otherwise: the meaning of “a,” “an,” and “the” includes plural reference.

The term “alkyl”, by itself or as part of another substituent, includes, unless otherwise stated, a straight or branched chain hydrocarbon radical, having the number of carbon atoms designated (i.e. C₁₋₈ means one to eight carbons). Examples of alkyl groups include methyl, ethyl, n-propyl, isopropyl, n-butyl, t-butyl, isobutyl, sec-butyl, n-pentyl, n-hexyl, n-heptyl, n-octyl, and the like.

The term “alkylene” by itself or as part of another substituent includes a linear or branched saturated divalent hydrocarbon radical derived from an alkane having the number of carbon atoms indicated in the prefix. For example, (C₁-C₆)alkylene is meant to include methylene, ethylene, propylene, 2-methylpropylene, pentylene, and the like. Perfluoroalkylene means to an alkylene where all the hydrogen atoms are substituted by fluorine atoms. Fluoroalkylene means to an alkylene where hydrogen atoms are partially substituted by fluorine atoms.

The terms “halo” or “halogen,” by themselves or as part of another substituent, mean, unless otherwise stated, a fluorine, chlorine, bromine, or iodine atom.

The term “haloalkyl,” are meant to include monohaloalkyl and polyhaloalkyl. For example, the term “C₁₋₄ haloalkyl” is mean to include trifluoromethyl, 2,2,2-trifluoroethyl, 4-chlorobutyl, 3-bromopropyl, 3-chloro-4-fluorobutyl and the like.

The term “perfluoroalkyl” includes an alkyl where all the hydrogen atoms in the alkyl are substituted by fluorine atoms. Examples of perfluoroalkyl include —CF₃, —CF₂CF₃, —CF₂—CF₂CF₃, —CF(CF₃)₂, —CF₂CF₂CF₂CF₃, —CF₂CF₂CF₂CF₂CF₃ and the like.

The term “aryl” includes a monovalent monocyclic, bicyclic or polycyclic aromatic hydrocarbon radical of 5 to 10 ring atoms, which can be a single ring or multiple rings (up to three rings), which are fused together or linked covalently. More specifically the term aryl includes, but is not limited to, phenyl, biphenyl, 1-naphthyl, and 2-naphthyl, and the substituted forms thereof.

The term “positive electrode” refers to one of a pair of rechargeable lithium-ion cell electrodes that under normal circumstances and when the cell is fully charged will have the highest potential. This terminology is retained to refer to the same physical electrode under all cell operating conditions even if such electrode temporarily (e.g., due to cell overdischarge) is driven to or exhibits a potential below that of the other (the negative) electrode.

The term “negative electrode” refers to one of a pair of rechargeable lithium-ion cell electrodes that under normal circumstances and when the cell is fully charged will have the lowest potential. This terminology is retained to refer to the same physical electrode under all cell operating conditions even if such electrode is temporarily (e.g., due to cell overdischarge) driven to or exhibits a potential above that of the other (the positive) electrode.

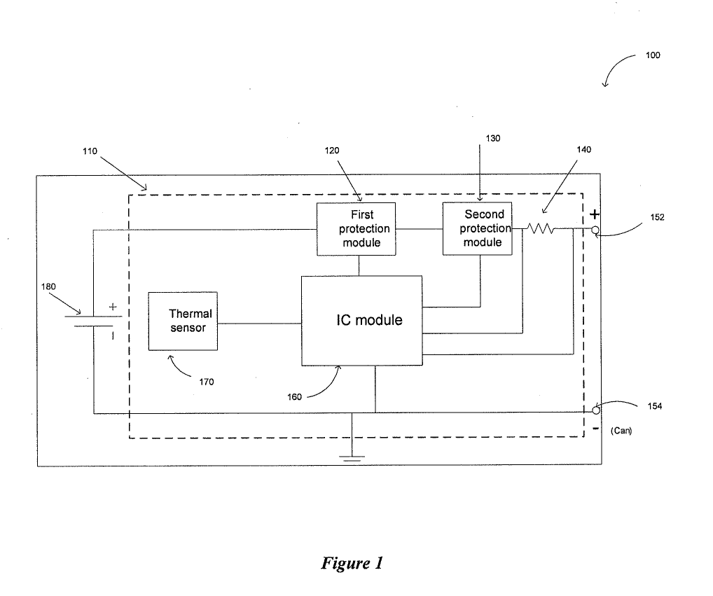

FIG. 1 is a schematic diagram illustrating a current interrupt device such as a protection circuit for protecting a lithium-ion cell according to an embodiment of the present invention. As shown in FIG. 1, the lithium-ion cell assembly 100 includes a lithium-ion cell component (lithium-ion cell) 180 and a protection circuit component (protection circuit)110. The lithium-ion cell component (lithium-ion cell) 180 and the protection circuit component (protection circuit) 110 are disposed within the lithium-ion cell assembly 100. The lithium-ion cell component (lithium-ion cell) 180 includes a lithium-ion cell 180 having a positive electrode, a negative electrode, a current collector and an electrolyte solution. A preferred lithium-ion cell is described in U.S. Pat. No. 6,699,623, which is incorporated herein by reference in its entirety. The protection circuit component (protection circuit) 110 includes a first protection module 120, a second protection module 130, a thermal sensor 170, an integrated circuit (IC) 160, a resistor 140, a positive connecting terminal 152 and a negative connecting terminal 154.

The protection circuit 110 is coupled between the lithium-ion cell 180 and the connection terminals 152 and 154 for cutting off the circuit loop to assure the safety of the lithium-ion cell assembly 100 when the current, voltage, or temperature in the lithium-ion battery 100 is abnormal. Exemplary abnormal cell conditions include overcharge, over-current, over-voltage, over-discharge, high temperature and short circuit. The protection circuit 110 includes a first protection module 120, an integrated circuit (IC) module 160, a resistor and a thermal sensor. The first protection module 120 is coupled between the lithium-ion cell 180 and the connection terminals 152 and 154. The first protection module 120 is used to conduct or cut off the circuit loop between the lithium-ion cell 180 and the connection terminals 152 and 154. The IC module 160 is coupled with the lithium-ion cell 180. The IC module 160 monitors the parameters of the lithium-ion cell 180, such as current, voltage, temperature, or the like and controls the first protection module 120 and second protection module 130 to conduct or cut off the circuit loop between the lithium-ion cell 180 and connection terminals 152 and 154. The resistor is coupled to the lithium-ion cell 180 and the connection terminals 152 and 154. The resistor provides the control of current and voltage of the lithium-ion cell 180. Thermal sensor 170 is in contact or disposed within the lithium-ion cell 180 and connected to the IC module 160. The thermal sensor 170 is capable of accurately determining the temperature and the change of temperature, for example, with time within the lithium-ion cell 180.

The first protection module 120 includes at least one control switch. The at least one control switch is coupled between the lithium-ion cell 180 and the terminals 152 and 154. The control switch is controlled by the IC module 160 to conduct or cut off the circuit loop between the lithium-ion cell 180 and the terminals 152 and 154. In one embodiment, the control switch can be implemented by a field-effect transistor.

In some embodiments, the IC module 160 includes a sensor, a signal converting circuit and a control circuit. In certain instances, the IC module further includes a voltage unit and a current unit. The monitoring mechanism is well-known in the art. In some embodiments, the voltage unit monitors the voltage of the lithium-ion cell 180 and limits this voltage in the event the voltage exceeds a safe value. The current unit monitors current charge and current discharge rates when the lithium-ion cell 180 is recharged by a charging unit or is drained, during usage. In each case, if the current flow rate is too high, the unit acts to limit or interrupt the current flow.

In some embodiments, the IC module monitors the charging and discharging current of the cell 180. In each case if the current flow rate is too high or exceeds a predetermined or safe value, the IC module opens the control switch 120 to cut off the circuit loop between the cell 180 and terminals 152 and 154. For example, in a 2 amperes power cell, the predetermined cutoff current is 5 mA. In a lithium-cobalt oxide cell, with an operating voltage of 2.5 to 4.2 V, the predetermined cutoff voltage is about 4.3 V. In certain instances, the predetermined current or voltage is about 5 to 10% , such as 5, 6, 7, 8, 9, or 10% above the maximum operating current or voltage.

The resistor 140 is a current limiting resistor which has considerable power handling capacity. In one embodiment, the resistor 140 is used to limit current which is supplied by the lithium-ion cell 180 to the circuit 110, in order to prevent any component in the circuit 110 from fusing. On the other hand the rating of the resistor 140 is such that, even if an over-current situation does occur, the resistor will not fuse. Fusing of electrical components is to be avoided as far as is possible, for fusing inevitably results in localized high temperatures which can be dangerous in a hazardous atmosphere.

The protection circuit 110 further includes a second protection module 130, which is coupled between the lithium-ion cell 180 and the connection terminals 152 and 154. The second protection module 130 monitors the current of the circuit loop between the lithium-ion cell 180 and the terminals 152 and 154 to conduct or cut off the circuit loop between the lithium-ion cell 180 and the terminals 152 and 154. In one embodiment, the second protection module 130 includes a circuit-cutting element in response to an over-current or a short circuit. The circuit-cutting element is coupled between the lithium-ion cell 180 and terminals 152 and 154. When the current flowing through the circuit-cutting element is larger than a pre-determined current, the circuit cutting element cuts off the circuit loop between the lithium-ion cell 180 and the terminals 152 and 154. In one embodiment, the circuit-cutting element can be a fuse. The rating current of the fuse matches with the operation current of the lithium-ion cell 180 so that the goal for protecting the lithium-ion cell 180 can be achieved.

In some embodiments, the fuse also senses the temperature of the lithium-ion cell 180. If the current or the temperature of the cell 180 is too high or above the threshold level, the fuse breaks and cuts off the circuit between the lithium-ion cell 180 and the terminals 152 and 154.

In one embodiment, the IC module 160 provides directly monitoring of the current, voltage and temperature of the lithium-ion cell 180. The IC module 160 monitors the parameters, such as current, voltage, or temperature, etc of the cell and controls the first protection module 120 to cut off the circuit loop between the lithium-ion cell 180 and the terminals 152 and 154 when the parameters of the lithium-ion cell 180 are abnormal. Exemplary abnormal cell conditions include overcharged, over-discharged, over-current, over-voltage, high temperature and short circuit.

Suitable thermal sensor 170 includes any temperature sensing device including, but not limiting to, a thermal couple and a thermistor. In one embodiment, the thermal sensor is in direct contact with the lithium-ion cell 180.

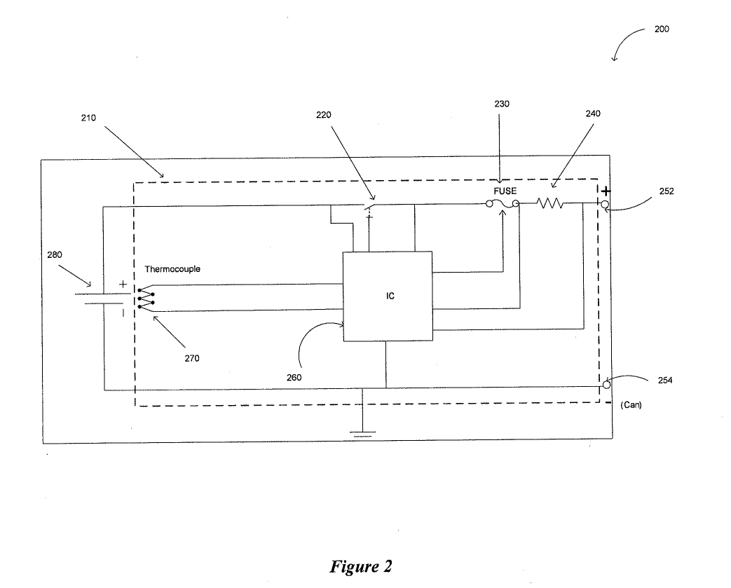

FIG. 2 shows a preferred embodiment of the present invention. The lithium-ion cell assembly 200 includes a lithium-ion cell component (lithium-ion cell) 280 and a protection circuit component (protection circuit) 210. The protection circuit component (protection circuit) 210 includes a control switch 220, a fuse 230, a thermocouple 270, a resistor 240 and an integrated circuit (IC) 260. In one embodiment, the thermocouple is in contact with the cell 280. The thermocouple 270 is coupled to the IC module 260 and is capable of determining the temperature and the change of temperature with time of lithium-ion cell 280. If the temperature in the lithium-ion cell 280 is too high, or exceeds a predetermined value, or the change of temperature with time deviates from a predetermined value, the switch 220 cuts off the circuit between the lithium-ion cell 280 and terminals 252 and 254. In some embodiments, the IC module 260 monitors the charging and discharging current of the lithium-ion cell 280. In each case, if the current flow rate is too high or exceeds a predetermined or safe value, the IC module opens the control switch 220 to cut off the circuit loop between lithium-ion cell 280 and terminals 252 and 254.

In one embodiment, IC module 160 can control the first protection module 120 or 130 to cut off the circuit in response to a temperature greater than 40, 50, 60, 70, 80, 90, 100, 110, 120, 130, 140 or 150° C. In another embodiment, IC module 260 can control switch 220 or fuse 230 to cut off the circuit in response to a temperature greater than 40, 50, 60, 70, 80, 90, 100, 110, 120, 130, 140 or 150° C.

In another embodiment, the present invention provides a use of a protection circuit disposed within a lithium-ion assembly for protection of a lithium-ion cell from over current, over voltage and high temperature, wherein the lithium-ion cell assembly is in electrical communication with the protection circuit.

In some embodiments, the lithium-ion cell 180 or 280 comprises a positive electrode, a negative electrode, an electrolyte solution comprising a medium and a lithium compound of formula I:

R¹—X⁻(Li⁺)R²(R³)ₘ, (I)

wherein the subscript m is 0 or 1, with the proviso that R¹ and R² are other than hydrogen when m=0, and no more than one of R¹, R² and R³ is hydrogen when m=1.

R¹, R² and R³ are each independently an electron-withdrawing group selected from the group consisting of —CN, —SO₂R^{a}, —SO₂-L^{a}-SO₂N⁻Li⁺SO₂R^{a}, —P(O)(OR^{a})₂, —CO₂R^{a}, —C(O)R^{a} and —H. Each R^{a} is independently selected from the group consisting of C₁₋₈ alkyl, C₁₋₈haloalkyl, C₁₋₈ perfluoroalkyl, aryl, optionally substituted barbituric acid and optionally substituted thiobarbituric acid, wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{b}, —P(O)(OR^{b})₂, —P(O)(R^{b})₂, —CO₂R^{b} and —C(O)R^{b}, wherein R^{b} is C₁₋₈ alkyl or C₁₋₈ perfluoroalkyl, and L^{a} is C₁₋₄perfluoroalkylene. The substituents for barbituric acid and thiobarbituric acid include alkyl, halogen, C₁₋₄haloalkyl, C₁₋₄perfluoroalkyl, —CN, —SO₂R^{b}, —P(O)(OR^{b})₂, —P(O)(R^{b})₂, —CO₂R^{b} and —C(O)R^{b}. In some embodiments, L^{a} is —CF₂— or —CF₂—CF₂—. In one embodiment, R¹ is —SO₂R^{a}. In some instances, R¹ is —SO₂(C₁₋₈perfluoroalkyl). For example, R¹ is —SO₂CF₃, —SO₂CF₂CF₃, —SO₂(perfluoropgenyl) and the like. In some other instances, when m is 0, R¹ is —SO₂(C₁₋₈perfluoroalkyl) and R² is —SO₂(C₁₋₈perfluoroalkyl) or —SO₂(-L^{a}-SO₂Li⁺)SO₂—R^{a}, wherein L^{a} is C₁₋₄perfluoroalkylene and R^{a} is C₁₋₈perfluoroalkyl, wherein one to four carbon-carbon bonds are optionally replaced with —O— to form an ether linkage. For example, each R^{a} is independently selected from the group consisting of —CF₃, —OCF₃, —CF₂CF₃, —CF₂—SCF₃, —CF₂—OCF₃, —CF₂CF₂—OCF₃, —CF₂—O—CF₂—OCF₂CF₂—O—CF₃C₁₋₈fluoroalkyl, perfluorophenyl, 2,3,4-trifluorophenyl, trifluorophenyl, 2,3,5-trifluorophenyl, 2,3,6-trifluorophenyl, 3,4,5-trifluorophenyl, 3,5,6-trifluorophenyl, 4,5,6-trifluorophenyl, trifluoromethoxyphenyl and bis-trifluoromethylphenyl, 2,3-bis-trifluoromethylphenyl, 2,4-bis-trifluoromethylphenyl, 2,5-bis-trifluoromethylphenyl, 2,6-bis-trifluoromethylphenyl, 3,4-bis-trifluoromethylphenyl, 3,5-bis-trifluoromethylphenyl, 3,6-bis-trifluoromethylphenyl, 4,5-bis-trifluoromethylphenyl and 4,6-bis-trifluoromethylphenyl. In certain instances, R¹ is —SO₂(C₁₋₈fluoroalkyl). C₁₋₈fluoroalkyl includes alkyls having up to 17 fluorine atoms and is also meant to include various partially fluorinated alkyls, such as —CH₂CF₃, —CH₂—OCF₃, —CF₂CH₃, —CHFCHF₂, —CHFCF₃, —CF₂CH₂CF₃ and the like.

In formula (I), L^{a} is C₁₋₅perfluoroalkylene, such as —CF₂—, —CF₂CF₂—, —CF₂CF₂CF₂—, —CF₂CF₂CF₂CF₂—, —CF₂CF(CF₃)—CF₂— and isomers thereof.

The symbol X is N when m is 0. X is C when m is 1.

In certain embodiments, the compounds of formula I is selected from the group consisting of: CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅, CF₃SO₂N⁻(Li⁺)SO₂PhCF₃, CF₃SO₂C⁻(Li⁺)(SO₂CF₃)₂, CF₃CF₂SO₂C⁻(Li⁺)(SO₂CF₃)₂, CF₃CF₂SO₂C⁻(Li⁺)(SO₂CF₂CF₃)₂, (CF₃SO₂)₂C⁻(Li⁺)SO₂CF₂OCF₃, CF₃SO₂C⁻(Li⁺)(SO₂CF₂OCF₃)₂, CF₃OCF₂SO₂C⁻(Li⁺)(SO₂CF₂OCF₃)₂, C₆F₅SO₂C⁻(Li⁺)(SO₂CF₃)₂, (C₆F₅SO₂)₂C⁻(Li⁺)SO₂CF₃, C₆F₅SO₂C⁻(Li⁺)(SO₂C₆F₅)₂, (CF₃SO₂)₂C⁻(Li⁺SO₂PhCF₃ and CF₃SO₂C⁻(Li⁺)(SO₂PhCF₃)₂. In some embodiments, the compounds are preferably CF₃SO₂N⁻(Li⁺)SO₂CF₃, CF₃SO₂C⁻(Li⁺)(SO₂CF₃)₂ or C₆F₅SO₂N⁻(Li⁺)SO₂C₆F₅.

The positive electrode, which includes electrode active materials and a current collector. The positive electrode has an upper charging voltage of 3.5-4.5 volts versus a Li/Li⁺ reference electrode. The upper charging voltage is the maximum voltage to which the positive electrode may be charged at a low rate of charge and with significant reversible storage capacity. In some embodiments, cells utilizing positive electrode with upper charging voltages from 3-5.8 volts versus a Li/Li⁺ reference electrode are also suitable. A variety of positive electrode active materials can be used. Non-limiting exemplary electrode active materials include transition metal oxides, phosphates and sulfates, and lithiated transition metal oxides, phosphates and sulfates.

In some embodiments, the electrode active materials are oxides with empirical formula LiₓMO₂, where M is a transition metal ions selected from the group consisting of Mn, Fe, Co, Ni, Al, Mg, Ti, V, and a combination thereof, with a layered crystal structure, the value x may be between about 0.01 and about 1, suitably between about 0.5 and about 1, more suitably between about 0.9 to 1. In yet some other embodiments, the active materials are oxides with empirical formula Liᵢ₊ₓM_{2-y}O₄, where M is a transition metal ions selected from the group consisting of Mn, Co, Ni, Al, Mg, Ti, V, and a combination thereof, with a spinel crystal structure, the value x may be between about −0.11 and 0.33, suitably between about 0 and about 0.1, the value of y may be between about 0 and 0.33, suitably between 0 and 0.1. In yet some other embodiments the active materials are vanadium oxides such as LiV₂O₅, LiV₆O₁₃, LiₓV₂O₅, LiₓV₆O₁₃, wherein x is 0<x<1 or the foregoing compounds modified in that the compositions thereof are nonstoichiometric, disordered, amorphous, overlithiated, or underlithiated forms such as are known in the art. The suitable positive electrode-active compounds may be further modified by doping with less than 5% of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺, Co³⁺, or Mn³⁺, and the like. In some other embodiments, positive electrode active materials suitable for the positive electrode composition include lithium insertion compounds with olivine structure such as LiₓMXO₄ where M is a transition metal ions selected from the group consisting of Fe, Mn, Co, Ni, and a combination thereof, and X is a selected from a group consisting of P, V, S, Si and combinations thereof, the value of the value x may be between about 0 and 2. In some other embodiments, the active materials with NASICON structures such as YₓM₂(XO₄)₃, where Y is Li or Na, or a combination thereof, M is a transition metal ion selected from the group consisting of Fe, V, Nb, Ti, Co, Ni, Al, or the combinations thereof, and X is selected from a group of P, S, Si, and combinations thereof and value of x between 0 and 3. The examples of these materials are disclosed by J. B. Goodenough in “Lithium Ion Batteries” (Wiley-VCH press, Edited by M. Wasihara and O. Yamamoto). Particle size of the electrode materials are preferably between 1 nm and 100 μm, more preferably between 10 nm and 100 um, and even more preferably between 1 μm and 100 μm.

In some embodiments, the electrode active materials are oxides such as LiCoO₂, spinel LiMn₂O₄, chromium-doped spinel lithium manganese oxides LiₓCr_{y}Mn₂O₄, layered LiMnO₂, LiNiO₂, LiNiₓCo₁₋ₓO₂ where x is 0<x<1, with a preferred range of 0.5<x<0.95, and vanadium oxides such as LiV₂O₅, LiV₆O₁₃, LiₓV₂O₅, LiₓV₆O₁₃, where x is 0<x<1, or the foregoing compounds modified in that the compositions thereof are nonstoichiometric, disordered, amorphous, overlithiated, or underlithiated forms such as are known in the art. The suitable positive electrode-active compounds may be further modified by doping with less than 5% of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺, Co³⁺, or Mn³⁺, and the like. In some other embodiments, positive electrode active materials suitable for the positive electrode composition include lithium insertion compounds with olivine structure such as LiFePO₄ and with NASICON structures such as LiFeTi(SO₄)₃, or those disclosed by J. B. Goodenough in “Lithium Ion Batteries” (Wiley-VCH press, Edited by M. Wasihara and O. Yamamoto). In yet some other embodiments, electrode active materials include LiFePO₄, LiMnPO₄, LiVPO₄, LiFeTi(SO₄)₃, LiNiₓMn₁₋ₓO₂, LiNiₓCo_{y}Mn_{1-x-y}O₂ and derivatives thereof, wherein x is 0<x<1 and y is 0<y<1. In certain instances, x is between about 0.25 and 0.9. In one instance, x is ⅓ and y is ⅓. Particle size of the positive electrode active material should range from about 1 to 100 microns. In some preferred embodiments, transition metal oxides such as LiCoO₂, LiMn₂O₄, LiNiO₂, LiNiₓMn₁₋ₓO₂, LiNiₓCo_{y}Mn_{1-x-y}O₂ and their derivatives, where x is 0<x<1 and y is 0<y<1. LiNiₓMn₁₋ₓO₂ can be prepared by heating a stoichiometric mixture of electrolytic MnO₂, LiOH and nickel oxide to about 300 to 400° C. In some other embodiments, the electrode active materials are xLi₂MnO₃(1-x)LiMO₂ or LiM'PO₄, where M is selected from Ni, Co, Mn, LiNiO₂ or LiNiₓCo₁₋ₓO₂; M′ is selected from the group consisting of Fe, Ni, Mn and V; and x and y are each independently a real number between 0 and 1. LiNiₓCo_{y}Mn_{1-x-y}O₂ can be prepared by heating a stoichiometric mixture of electrolytic MnO₂, LiOH, nickel oxide and cobalt oxide to about 300 to 500° C. The positive electrode may contain conductive additives from 0% to about 90%, preferably the additive is less than 5%. In one embodiment, the subscripts x and y are each independently selected from 0.1, 0.15, 0.2, 0.25, 0.3, 0.35, 0.4, 0.45, 0.5, 0.55, 0.6, 0.65, 0.7, 0.75, 0.8, 0.85, 0.9 or 0.95. x and y can be any numbers between 0 and 1 to satisfy the charge balance of the compounds LiNiₓMn₁₋ₓO₂ and LiNiₓCo_{y}Mn_{1-x-y}O₂.

Representative positive electrodes and their approximate recharged potentials include FeS₂ (3.0 V vs. Li/Li⁺), LiCoPO₄ (4.8 V vs. Li/Li⁺), LiFePO₄ (3.45 V vs. Li/Li⁺), Li₂FeS₂ (3.0 V vs. Li/Li⁺), Li₂FeSiO₄ (2.9 V vs. Li/Li⁺), LiMn₂O₄ (4.1 V vs. Li/Li⁺), LiMnPO₄ (4.1 V vs. Li/Li⁺), LiNiPO₄ (5.1 V vs. Li/Li⁺), LiV₃O₈ (3.7 V vs. Li/Li⁺), LiV₆O₁₃ (3.0 V vs. Li/Li⁺), LiVOPO₄ (4.15 V vs. Li/Li⁺), LiVOPO₄F (4.3 V vs. Li/Li⁺), Li₃ V₂(PO₄)₃ (4.1 V (2 Li) or 4.6 V (3 Li) vs. Li/Li⁺), MnO₂ (3.4 V vs. Li/Li⁺), MoS₃ (2.5 V vs. Li/Li⁺), sulfur (2.4 V vs. Li/Li⁺), TiS₂(2.5 V vs. Li/Li⁺), TiS₃ (2.5 V vs. Li/Li⁺), V₂O₅ (3.6 V vs. Li/Li⁺), V₆O₁₃ (3.0 V vs. Li/Li⁺), and combinations thereof.

A positive electrode can be formed by mixing and forming a composition comprising, by weight, 0.01-15%, preferably 2-15%, more preferably 4-8%, of a polymer binder, 10-50%, preferably 15-25%, of the electrolyte solution of the invention herein described, 40-85%, preferably 65-75%, of an electrode-active material, and 1-12%, preferably 4-8%, of a conductive additive. Optionally, up to 12% of inert filler may also be added, as may such other adjuvants as may be desired by one of skill in the art, which do not substantively affect the achievement of the desirable results of the present invention. In one embodiment, no inert filler is used.

The negative electrode, which includes electrode active materials and a current collector. The negative electrode comprises either a metal selected from the group consisting of Li, Si, Sn, Sb, Al and a combination thereof, or a mixture of one or more negative electrode active materials in particulate form, a binder, preferably a polymeric binder, optionally an electron conductive additive, and at least one organic carbonate. Examples of useful negative electrode active materials include, but are not limited to, lithium metal, carbon (graphites, coke-type, mesocarbons, polyacenes, carbon nanotubes, carbon fibers, and the like). Negative electrode-active materials also include lithium-intercalated carbon, lithium metal nitrides such as Li₂₆Co_{0.4}N, metallic lithium alloys such as LiAl or Li₄Sn, lithium-alloy-forming compounds of tin, silicon, antimony, or aluminum such as those disclosed in “Active/Inactive Nanocomposites as Anodes for Li-Ion Batteries,” by Mao et al. in Electrochemical and Solid State Letters, 2 (1), p. 3, 1999. Further included as negative electrode-active materials are metal oxides such as titanium oxides, iron oxides, or tin oxides. When present in particulate form, the particle size of the negative electrode active material should range from about 0.01 to 100 microns, preferably from 1 to 100 microns. Some preferred negative electrode active materials include graphites such as carbon microbeads, natural graphites, carbon nanotubes, carbon fibers, or graphitic flake-type materials. Some other preferred negative electrode active materials are graphite microbeads and hard carbon, which are commercially available.

A negative electrode can be formed by mixing and forming a composition comprising, by weight, 0.01-20%, or 1-20%, preferably 2-20%, more preferably 3-10%, of a polymer binder, 10-50%, preferably 14-28%, of the electrolyte solution of the invention herein described, 40-80%, preferably 60-70%, of electrode-active material, and 0-5%, preferably 1-4%, of a conductive additive. Optionally up to 12% of an inert filler as hereinabove described may also be added, as may such other adjuvants as may be desired by one of skill in the art, which do not substantively affect the achievement of the desirable results of the present invention. It is preferred that no inert filler be used.

Suitable conductive additives for the positive and negative electrode composition include carbons such as coke, carbon black, carbon nanotubes, carbon fibers, and natural graphite, metallic flake or particles of copper, stainless steel, nickel or other relatively inert metals, conductive metal oxides such as titanium oxides or ruthenium oxides, or electronically-conductive polymers such as polyacetylene, polyphenylene and polyphenylenevinylene, polyaniline or polypyrrole. Preferred additives include carbon fibers, carbon nanotubes and carbon blacks with relatively surface area below ca. 100 m²/g such as Super P and Super S carbon blacks available from MMM Carbon in Belgium.

The current collector suitable for the positive and negative electrodes includes a metal foil and a carbon sheet selected from a graphite sheet, carbon fiber sheet, carbon foam and carbon nanotubes sheet or film. High conductivity is generally achieved in pure graphite and carbon nanotubes film so it is preferred that the graphite and nanotube sheeting contain as few binders, additives and impurities as possible in order to realize the benefits of the present invention. Carbon nanotubes can be present from 0.01% to about 99%. Carbon fiber can be in microns or submicrons. Carbon black or carbon nanotubes may be added to enhance the conductivities of the certain carbon fibers. In one embodiment, the negative electrode current collector is a metal foil, such as copper foil. The metal foil can have a thickness from about 5 to about 300 micrometers.

The carbon sheet current collector suitable for the present invention may be in the form of a powder coating on a substrate such as a metal substrate, a free-standing sheet, or a laminate. That is the current collector may be a composite structure having other members such as metal foils, adhesive layers and such other materials as may be considered desirable for a given application. However, in any event, according to the present invention, it is the carbon sheet layer, or carbon sheet layer in combination with an adhesion promoter, which is directly interfaced with the electrolyte of the present invention and is in electronically conductive contact with the electrode surface.

In some embodiments, resins are added to fill into the pores of carbon sheet current collectors to prevent the passing through of electrolyte. The resin can be conductive or non-conductive. Non-conductive resins can be used to increase the mechanical strength of the carbon sheet. The use of conductive resins have the advantage of increasing initial charge efficiency, decrease surface area where passivation occurs due to the reaction with the electrolyte. The conductive resin can also increase the conductivity of the carbon sheet current collector.

The flexible carbon sheeting preferred for the practice of the present invention is characterized by a thickness of at most 2000 micrometers, with less than 1000, preferred, less than 300 more preferred, less than 75 micrometers even more preferred, and less than 25 micrometers most preferred. The flexible carbon sheeting preferred for the practice of the invention is further characterized by an electrical conductivity along the length and width of the sheeting of at least 1000 Siemens/cm (S/cm), preferably at least 2000 S/cm, most preferably at least 3000 S/cm measured according to ASTM standard C611-98.

The flexible carbon sheeting preferred for the practice of the present invention may be compounded with other ingredients as may be required for a particular application, but carbon sheet having a purity of ca. 95% or greater is highly preferred. In some embodiments, the carbon sheet has a purity of greater than 99%. At a thickness below about 10 μm, it may be expected that electrical resistance could be unduly high, so that thickness of less than about 10 μm is less preferred.

In some embodiments, the carbon current collector is a flexible free-standing graphite sheet. The flexible free-standing graphite sheet cathode current collector is made from expanded graphite particles without the use of any binding material. The flexible graphite sheet can be made from natural graphite, Kish flake graphite, or synthetic graphite that has been voluminously expanded so as to have d₀₀₂ dimension at least 80 times and preferably 200 times the original d₀₀₂ dimension. Expanded graphite particles have excellent mechanical interlocking or cohesion properties that can be compressed to form an integrated flexible sheet without any binder. Natural graphites are generally found or obtained in the form of small soft flakes or powder. Kish graphite is the excess carbon which crystallizes out in the course of smelting iron. In one embodiment, the current collector is a flexible free-standing expanded graphite. In another embodiment, the current collector is a flexible free-standing expanded natural graphite.

A binder is optional, however, it is preferred in the art to employ a binder, particularly a polymeric binder, and it is preferred in the practice of the present invention as well. One of skill in the art will appreciate that many of the polymeric materials recited below as suitable for use as binders will also be useful for forming ion-permeable separator membranes suitable for use in the lithium or lithium-ion battery of the invention.

Suitable binders include, but are not limited to, polymeric binders, particularly gelled polymer electrolytes comprising polyacrylonitrile, poly(methylmethacrylate), poly(vinyl chloride), and polyvinylidene fluoride and copolymers thereof. Also, included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers comprising partially or fully fluorinated polymer backbones, and having pendant groups comprising fluorinated sulfonate, imide, or methide lithium salts. Preferred binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers comprising monomer units of polyvinylidene fluoride and monomer units comprising pendant groups comprising fluorinated carboxylate, sulfonate, imide, or methide lithium salts.

Gelled polymer electrolytes are formed by combining the polymeric binder with a compatible suitable aprotic polar solvent and, where applicable, the electrolyte salt. PEO and PPO-based polymeric binders can be used without solvents. Without solvents, they become solid polymer electrolytes, which may offer advantages in safety and cycle life under some circumstances. Other suitable binders include so-called “salt-in-polymer” compositions comprising polymers having greater than 50% by weight of one or more salts. See, for example, M. Forsyth et al, Solid State Ionics, 113, pp 161-163 (1998).

Also included as binders are glassy solid polymer electrolytes, which are similar to the “salt-in-polymer” compositions except that the polymer is present in use at a temperature below its glass transition temperature and the salt concentrations are ca. 30% by weight. In one embodiment, the volume fraction of the preferred binder in the finished electrode is between 4 and 40%.

Electrolyte solvents can be aprotic liquids or polymers. Included are organic carbonates and lactones. Organic carbonates include a compound having the formula: R⁴OC(═O)OR⁵, wherein R⁴ and R⁵ are each independently selected from the group consisting of C₁₋₄alkyl and C₃₋₆cycloalkyl, or together with the atoms to which they are attached to form a 4- to 8-membered ring, wherein the ring carbons are optionally substituted with 1-2 members selected from the group consisting of halogen, C₁₋₄alkyl and C₁₋₄haloalkyl. In one embodiment, the organic carbonates include propylene carbonate, dimethyl carbonate, ethylene carbonate, diethyl carbonate, ethylmethyl carbonate and a mixture thereof as well as many related species. The lactone is selected from the group consisting of β-propiolactone, γ-butyrolactone, δ-valerolactone, ε-caprolactone, hexano-6-lactone and a mixture thereof, each of which is optionally substituted with from 1-4 members selected from the group consisting of halogen, C₁₋₄alkyl and C₁₋₄haloalkyl. Also included are solid polymer electrolytes such as polyethers and poly(organo phosphazenes). Further included are lithium salt-containing ionic liquid mixtures such as are known in the art, including ionic liquids such as organic derivatives of the imidazolium cation with counterions based on imides, methides, PF₆⁻, or BF₄⁻. See for example, MacFarlane et al., Nature, 402, 792 (1999). Mixtures of suitable electrolyte solvents, including mixtures of liquid and polymeric electrolyte solvents are also suitable.

The electrolyte solution suitable for the practice of the invention is formed by combining the lithium imide or methide salts of compounds of formula I with optionally a co-salt selected from LiPF₆, LiBF₄, LiAsF₆, LiB(C₂O₄)₂, (Lithium bis(oxalato)borate), or LiClO₄, along with a non-aqueous electrolyte solvent by dissolving, slurrying or melt mixing as appropriate to the particular materials. The present invention is operable when the concentration of the imide or methide salt is in the range of 0.2 to up to 3 molar, but 0.5 to 2 molar is preferred, with 0.8 to 1.2 molar most preferred. Depending on the fabrication method of the cell, the electrolyte solution may be added to the cell after winding or lamination to form the cell structure, or it may be introduced into the electrode or separator compositions before the final cell assembly.

The electrochemical cell optionally contains an ion conductive layer. The ion conductive layer suitable for the lithium or lithium-ion battery of the present invention is any ion-permeable shaped article, preferably in the form of a thin film, membrane or sheet. Such ion conductive layer may be an ion conductive membrane or a microporous film such as a microporous polypropylene, polyethylene, polytetrafluoroethylene and layered structures thereof Suitable ion conductive layer also include swellable polymers such as polyvinylidene fluoride and copolymers thereof Other suitable ion conductive layer include those known in the art of gelled polymer electrolytes such as poly(methyl methacrylate) and poly(vinyl chloride). Also suitable are polyethers such as poly(ethylene oxide) and poly(propylene oxide). Preferable are microporous polyolefin separators, separators comprising copolymers of vinylidene fluoride with hexafluoropropylene, perfluoromethyl vinyl ether, perfluoroethyl vinyl ether, or perfluoropropyl vinyl ether, including combinations thereof, or fluorinated ionomers, such as those described in Doyle et al., U.S. Pat. No. 6,025,092.

The Li-ion electrochemical cell can be assembled according to any method known in the art (see, U.S. Pat. Nos. 5,246,796; 5,837,015; 5,688,293; 5,456,000; 5,540,741; and 6,287,722 as incorporated herein by reference). In a first method, electrodes are solvent-cast onto current collectors, the collector/electrode tapes are spirally wound along with microporous polyolefin separator films to make a cylindrical roll, the winding placed into a metallic cell case, and the nonaqueous electrolyte solution impregnated into the wound cell. In a second method electrodes are solvent-cast onto current collectors and dried, the electrolyte and a polymeric gelling agent are coated onto the separators and/or the electrodes, the separators are laminated to, or brought in contact with, the collector/electrode tapes to make a cell subassembly, the cell subassemblies are then cut and stacked, or folded, or wound, then placed into a foil-laminate package, and finally heat treated to gel the electrolyte. In a third method, electrodes and separators are solvent cast with also the addition of a plasticizer; the electrodes, mesh current collectors, electrodes and separators are laminated together to make a cell subassembly, the plasticizer is extracted using a volatile solvent, the subassembly is dried, then by contacting the subassembly with electrolyte the void space left by extraction of the plasticizer is filled with electrolyte to yield an activated cell, the subassembly(s) are optionally stacked, folded, or wound, and finally the cell is packaged in a foil laminate package. In a fourth method, the electrode and separator materials are dried first, then combined with the salt and electrolyte solvent to make active compositions; by melt processing the electrodes and separator compositions are formed into films, the films are laminated to produce a cell subassembly, the subassembly(s) are stacked, folded, or wound and then packaged in a foil-laminate container. In a fifth method, electrodes and separator are either spirally wound or stacked; polymeric binding agent (e.g., polyvinylidene (PVDF) or equivalent) is on separator or electrodes, after winding or stacking, heat lamination to melt the binding agent and adhere the layers together followed by electrolyte fill.

In one embodiment, the electrodes can conveniently be made by dissolution of all polymeric components into a common solvent and mixing together with the carbon black particles and electrode active particles. For example, a lithium battery electrode can be fabricated by dissolving polyvinylidene (PVDF) in 1-methyl-2-pyrrolidinone or poly(PVDF-co-hexafluoropropylene (HFP)) copolymer in acetone solvent, followed by addition of particles of electrode active material and carbon black or carbon nanotubes, followed by deposition of a film on a substrate and drying. The resultant electrode will comprise electrode active material, conductive carbon black or carbon nanotubes, and polymer. This electrode can then be cast from solution onto a suitable support such as a glass plate or a current collector, and formed into a film using techniques well known in the art.

The positive electrode is brought into electronically conductive contact with the graphite current collector with as little contact resistance as possible. This may be advantageously accomplished by depositing upon the graphite sheet a thin layer of an adhesion promoter such as a mixture of an acrylic acid-ethylene copolymer and carbon black. Suitable contact may be achieved by the application of heat and/or pressure to provide intimate contact between the current collector and the electrode.

The flexible carbon sheeting, such as carbon nanotubes or graphite sheet for the practice of the present invention provides particular advantages in achieving low contact resistance. By virtue of its high ductility, conformability, and toughness it can be made to form particularly intimate and therefore low resistance contacts with electrode structures that may intentionally or unintentionally proffer an uneven contact surface. In any event, in the practice of the present invention, the contact resistance between the positive electrode and the graphite current collector of the present invention preferably does not exceed 50 ohm-cm², in one instance, does not exceed 10 ohms-cm², and in another instance, does not exceed 2 ohms-cm². Contact resistance can be determined by any convenient method as known to one of ordinary skill in the art. Simple measurement with an ohm-meter is possible.

The negative electrode is brought into electronically conductive contact with an negative electrode current collector. The negative electrode current collector can be a metal foil, a mesh or a carbon sheet. In one embodiment, the current collector is a copper foil or mesh. In a preferred embodiment, the negative electrode current collector is a carbon sheet selected from a graphite sheet, carbon fiber sheet or a carbon nanotube sheet. As in the case of the positive electrode, an adhesion promoter can optionally be used to attach the negative electrode to the current collector.

In one embodiment, the electrode films thus produced are then combined by lamination. In order to ensure that the components so laminated or otherwise combined are in excellent conically conductive contact with one another, the components are combined with an electrolyte solution comprising an aprotic solvent, preferably an organic carbonate as hereinabove described, and a lithium imide or methide salt represented by the formula I.

While certain novel features of this invention have been shown and described and are pointed out in the claims, it is not intended to be limited to the details above, since it will be understood that various omissions, modifications, substitutions and changes in the forms and details of the device illustrated and in its operation can be made by those skilled in the art without departing in any way from the spirit of the present invention. Each reference provided herein is incorporated by reference in its entirety to the same extent as if each reference was individually incorporated by reference.

What is claimed is:

1. A protection circuit disposed within a lithium-ion cell assembly, wherein the lithium-ion assembly includes a lithium-ion cell in electrical communication with said protection circuit, said circuit comprising:
a first and a second connection terminals for connecting to a charging device for charging the lithium-ion cell and/or a load device driven by a discharge current from the lithium-ion cell assembly;
a first protection module coupled between the lithium-ion cell and the first terminal for conducting or cutting off a first circuit loop between the lithium-ion cell and the first terminal or second terminal;
a second protection module coupled between the first protection module and the first terminal for conducting or cutting off a second circuit loop between the lithium-ion cell and the first terminal or second terminal;
an integrated circuit module coupled with the first protection module, the second protection module, the lithium-ion cell, the first terminal and the second terminal for monitoring the parameters of the lithium-ion cell and controlling the first and the second protection module to conduct or cut off the first circuit loop, the second circuit loop, or both, between the lithium-ion cell and the first and the second terminals;
a thermal sensor coupled to the integrated circuit, wherein the thermal sensor is in contact with the lithium-ion cell for detecting the temperature of the cell; and
a resistor coupled between the second protection module and the first terminal for measuring and controlling the current of the lithium-ion cell.

2. The protection circuit of claim 1, wherein the first protection module comprises a switch, wherein the switch is coupled to the integrated circuit module and cuts off the first circuit loop between the lithium-ion cell and the first terminal when the temperature of the lithium-ion cell is above a predetermined temperature or the rate of change of temperature is deviated from a predetermined value.

3. The protection circuit of claim 1, wherein the first protection module comprises a switch, wherein the switch is coupled to the integrated circuit module and cuts off the first circuit loop between the lithium-ion cell and the first terminal when the operation current of the integrated circuit is greater than a predetermined current or there is a short circuit.

4. The protection circuit of claim 1, wherein the first protection module comprises a switch, wherein the switch is coupled to the integrated circuit module and cuts off the first circuit loop between the lithium-ion cell and the first terminal when the voltage of the lithium-ion cell is greater than or lower than a predetermined voltage.

5. The protection circuit of claim 1, wherein the second protection module comprises a fuse, wherein the fuse is coupled to the integrated circuit module and cuts off the second circuit loop between the lithium-ion cell and the first terminal when the operation current of the integrated circuit is greater than a predetermined current or there is a short circuit.

6. The protection circuit of claim 1, wherein the integrated circuit is pre-programmed.

7. The protection circuit of claim 1, wherein said lithium-ion cell comprising a current collector and an electrolyte.

8. The protection circuit of claim 7, the electrolyte solution comprises a salt selected from the group consisting of LiPF₆, LiBF₄, LiClO₄ and a compound having the formula:
(R^{a}SO₂)N⁻Li⁺(SO₂R^{a}),
wherein each R^{a} is independently C₁₋₈perfluoroalkyl or perfluoroaryl.

9. The protection circuit of claim 8, wherein the electrolyte solution comprises a salt selected from CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃.

10. The protection circuit of claim 7, wherein the current collector is selected from the group consisting of a metal foil and a carbon sheet selected from a graphite sheet, a carbon fiber sheet, a carbon foam, a carbon nanotube film or a mixture thereof.

11. A lithium-ion cell assembly, comprising:
a lithium-ion cell;
a protection circuit; and
wherein the lithium-ion cell is in electrical communication with said protection circuit.

12. The lithium-ion cell assembly of claim 11, wherein the protection circuit comprises a first protection module comprising a switch.

13. The lithium-ion cell assembly of claim 11, wherein the protection circuit comprises a second protection module comprising a fuse.

14. The lithium-ion cell assembly of claim 11, wherein the protection circuit comprises a thermal sensor comprising a thermocouple.

15. The lithium-ion cell assembly of claim 11, wherein the lithium-ion cell comprises a carbon sheet current collector.

16. A lithium-ion battery, comprising:
one or more lithium-ion cell assemblies, each lithium-ion assembly comprises a lithium-ion cell in electrical communication with a protection circuit.

17. The battery of claim 16, wherein the protection circuit comprises a first protection module comprising a switch.

18. The battery of claim 16, wherein the protection circuit comprises a second protection module comprising a fuse.

19. The battery of claim 16, wherein the protection circuit comprises a thermal sensor comprising a thermocouple.

20. The battery of claim 16, wherein the lithium-ion cell comprises a carbon sheet current collector.
